(19) United States
(12) Patent Application Publication
(10) Pub. No.: US 2002/0135244 A1
(43) Pub. Date: Sep. 26, 2002

(54) Brushless D.C. motor

(76) Inventors: Scott Lewis Strong, Saginaw, MI (US); Sunil Keshava Murthy, Austin, TX (US)

Correspondence Address: EDMUND P. ANDERSON, DELPHI TECHNOLOGIES, INC., Legal Staff Mail Code: 480-414-420, P.O. Box 5052, Troy, MI, 48007-5052, US

(21) Appl. No.: 09/813,740

(22) Filed: Mar. 21, 2001

(51) Int. Cl. H02K 5/24

(52) U.S. Cl. 310/51; 318/258

(57) ABSTRACT

A brushless D.C. motor having a tolerance band that is used to retain the stator in the motor housing. The tolerance band has a plurality of waves formed along its length. The tolerance band is mounted within a housing groove, through which the stator is pressed. The tolerance band waves are compressed as the stator is pressed into motor housing. The compressed waves act as a radial spring to retain the stator in the housing with a minimal amount of radial force.

### TECHNICAL FIELD

The disclosure relates to reduction of torque ripple in brushless D.C. motors.

### BACKGROUND OF THE INVENTION

Electric motors are used in a wide variety of applications. One type of motor, the brushless D.C. motor, is generally preferred in applications which require little or no maintenance over the life of the application. In a permanent magnet brushless D.C. motor, a series of permanent magnets are mounted to a motor shaft. The magnets are surrounded by a stator which is attached to the motor housing. The stator is formed of individual sections which can be energized by a drive controller to create a magnetic field. The magnets on the shaft react toward this magnetic field, causing the shaft to turn. The drive controller operates the motor to the desired operating speed by sequentially energizing the stator sections to rotate the magnetic field around the motor. The rotating field causes the magnets to turn the shaft at an increasingly faster rate until the desired speed is achieved.

One inherent weakness with permanent magnet brushless D.C. motors is a phenomenon called torque ripple. Torque ripple is a fluctuation in the motor output torque as the motor operates. The torque ripple phenomenon comprises two major components; 1) cogging, and 2) commutation ripple. The cogging effect is caused by the rotor magnets attraction to the individual teeth contained in the stator. This attraction occurs even when the motor is not powered. The second component of torque ripple, called commutation ripple, is produced as the motor shaft is rotated. The torque generated by the motor will vary slightly as the magnets pass from the influence of one powered stator section to the next. The torque ripple effect is problematic in applications such as automobile power steering systems, where the torque ripple could cause a pulsing in the hand wheel that would be felt by the driver.

One method of reducing cogging is to skew the stator or magnets on the rotor. Skew is defined as the change in angular position of the magnet poles, or the stator teeth (as measured in a plane perpendicular to the axis of the motor), along the length of the axis of the motor. If the rotor magnet is skewed, the skew angle is defined as the angle between the centerline of the magnetic pole at one end of the rotor back iron, to the centerline of said at the other end. If the stator is skewed, the measurement is the same, except it is between stator teeth, or slots, at either end of the stator stack. Ideally, one slot skew gives zero cogging torque. While this method is efficient in reducing the cogging effect, it often does not eliminate the problem. Other techniques, such as reducing the press fit between the stator and the housing have been found effective in minimizing or eliminating cogging, and perhaps reducing commutation ripple as well. Unfortunately, this usually results in the use of additional mechanical fasteners or adhesives to secure the stator, increasing the complexity and the manufacturing cost of the motor. Furthermore, the securing devices or methods must work through a wide temperature range with dissimilar materials, in particular, materials having different coefficients of thermal expansion.

Another issue with permanent magnet brushless DC motors is noise, and vibration. In the case of automobile power steering systems, noise and vibration produced by the motor needs to be minimized if the steering system is to be accepted by the consumer. The act of commutating the motor produces noise and vibration in varying amounts, via a variety of mechanisms. Mechanical systems vibrate at their natural frequencies and all their sensitive frequencies when excited; and therefore, can produce objectionable noise at those frequencies. This excitation can be provided by motor commutation. Forced vibrations induced by the motor being commutated, can be objectionable if felt, and can become objectionable noise. Vibrations can be transmitted by the structure of the system, and emitted off as noise at various points along its path of travel. By changing the stiffness of the system, or any component in the transmission path, the transmitted vibration may be reduced. Additionally, if a damping material is introduced into this path, then any free vibration can be dissipated, and some energy may be removed from any transmitted vibration.

Thus, in keeping with the persistent quest to decrease costs and increase productivity, it is desirable to have a motor that operates over a wide temperature range, and where torque ripple, noise and vibration are eliminated, or greatly reduced, while requiring less labor and fewer parts to assemble.

### SUMMARY OF THE INVENTION

The present disclosure is directed to a brushless D.C. motor that alleviates the drawbacks of the prior art by providing a cost-effective motor that reduces torque ripple, and lessens noise and vibration, with a minimum amount of labor and parts. The foundation of the invention is a tolerance band, which when positioned between the stator and housing in such a motor, allows a minimal radial force on the stator, while still providing sufficient force to retain the stator therein. The permanent magnet brushless D.C. motor assembly comprises a motor housing supporting a shaft on a pair of bearings. The motor provides power via the shaft to drive a load such as a fan. The tolerance band is mounted inside a groove within the motor housing. After which, the stator is pressed into the tolerance band & housing sub-assembly. The tolerance band has a series of waves formed thereon, which are compressed as the stator is pressed into the motor housing. The compression of these waves creates a spring force, which retains the stator in the housing with a minimal amount of radial force.

### BRIEF DESCRIPTION OF THE DRAWINGS

FIG. 1 is a plan front view, partially in section of a brushless D.C. motor in accordance with the present invention;

FIG. 2 is a plan side view, partially in section, of the motor shown in FIG. 1; and

FIG. 3 is a perspective view of the tolerance band shown in FIG. 1.

### DETAILED DESCRIPTION OF THE INVENTION

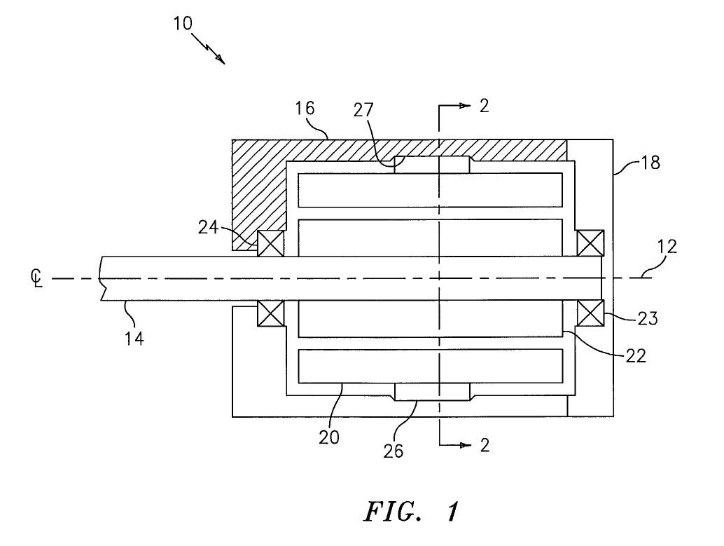

A permanent magnet brushless D.C. electric motor 10 in accordance with the present invention is shown in FIG. 1. Motors of this type are used in a wide variety of applications due to their long life and low maintenance requirements. The motor 10 has a shaft 12 that is generally interconnected with a load such as a gearbox (not shown), on its distal end 14. The motor 10 includes a housing 16 and an end cover 18 which encloses a stator 20, a rotor back iron 22, a set of rotor magnets 28, and a shaft 12 mounted on a pair of bearings 23/24. A tolerance band 26 is positioned between the stator 20 and the housing 16 as will be described in further detail hereinafter.

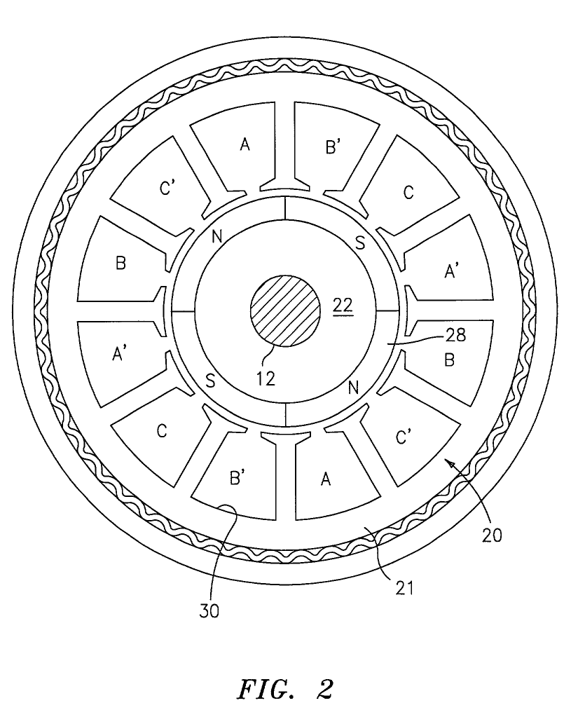

Referring now to FIG. 2, a side sectional view of the motor is provided. The back iron 22 is mounted on the shaft 12 and has four magnets 28, which have alternating magnetic charge. The stator 20 comprises a stack of laminations 21 defining a number of slots 30 and a number of coils 40. Typically, either the magnets 28 or the stator slots 30 are skewed with respect to each other in accordance with standard industry practice. It should be understood that the number of magnets 28 and stator slots 30 used herein are for exemplary purposes, and any number of magnets 28 or stator slots 30 could be used depending on the needs of the application. There are a number of coils 40 comprising the winding of a given motor. Each coil 40 is inserted through two of the slot openings 37, and around one or more teeth 38, depending on the electromagnetic design. Once the coil is inserted into the appropriate slots 30, the coil will produce a loop of copper at either end of the stator lamination stack 21. The coil loops at either end of the stack are commonly known as the end turns 39.

In operation, a drive controller (not shown) energizes the stator coils 40, to create a magnetic field. The magnets 28 on the back iron 22 react toward this magnetic field, causing the shaft 12 to turn, and produce torque. By sequentially energizing the stator coils 40 within the stator slots 30, the drive controller causes the magnetic field to rotate 360° around the motor 10, forcing the shaft 12 to turn on the bearings 23/24 at a increasingly faster rate until the desired speed is achieved. As described herein above, one side effect to permanent magnet brushless D.C. motors is a phenomenon known as torque ripple. As the magnets are pulled by the energized stator coils 40, there will be instances, where the magnet(s) 28 pass from the influence of one energized stator coil 40 to the next. At this point the magnetic force generated by the first energized stator coil 40 will be declining, and the next energized stator coil 40 will have not yet picked up the magnet. This results in a fluctuation or ripple in the torque output generated by the motor. This fluctuation is known as commutation ripple, or torque ripple due to commutation.

Another component of torque ripple is cogging as mentioned herein above. Cogging is produced with or without the stator 20 being energized. It is the effect produced as the magnets 28 are attracted toward the individual stator teeth 38. The attraction produces a moment on the back iron 22, and the shaft 12 rotates.

It has been found that by reducing the amount of press fit interference between the housing 16 and the stator 20 cogging will be minimized. Some applications require that the stator 20 and the housing 16 be made from different materials. For example, the stator is always made from some form of ferrous material, such as steel, since it is magnetic. The housing, however, can be made from other materials such as aluminum. Since all materials tend to expand when they are heated, a problem arises when dissimilar materials are assembled together, such as a steel stator 20 and aluminum housing 16, due to the difference in their rates of thermal expansion. The aluminum housing will grow at a faster rate than the steel stator, as the two parts are heated during operation. To compensate for this,a larger press fit interference is required to keep the parts from separating during operation. The larger press fit interference leads the motor back into a problem with cogging. It is thought that the press fit, which causes large radial loads to be applied to the lamination stack 21, distorts the bore 41 of the stack 21. The distortion of the bore 41 effects the air gap 42 of the motor. Maintaining the proper air gap 42 is important in the design and performance of a motor. Further, the high radial loads could be moving the teeth 38 of the lamination stack 21, which effects the slot openings 37 locations. These alterations in turn would effect cogging and commutation ripple. Cogging would be increased because the teeth 38, which the magnets 28 are attracted to, would not be in the correct location, and may not be uniformly distributed. If the stack had been one slot skewed, ideally providing zero cogging, now with the distortions, this would no longer be true, leading to an increase in cogging. Decreases in air gap 42, whether uniform or not, can also cause increases in cogging torque. Commutation ripple could be increased because the location of the stator electromagnet poles, as defined by the slots 37 when the chosen coils 40 are energized, would be altered, and worse, not necessarily uniformly altered. A much lighter press fit could be used for the stator 20 to resolve the distortion problem. Empirically, it has been found that the proper interference needs to be approximately 0.002″ to eliminate the cogging effect. However, this solution is unsatisfactory due to the thermal expansion issues. To solve these conflicting requirements, a tolerance band 26 is employed to secure the stator 20 to the housing 16. Tolerance band 26 allows for the employment of a light radial force, which is equivalent to that provided by the press fit interference of about 0.002″, while still securing stator 20 inside of housing 16.

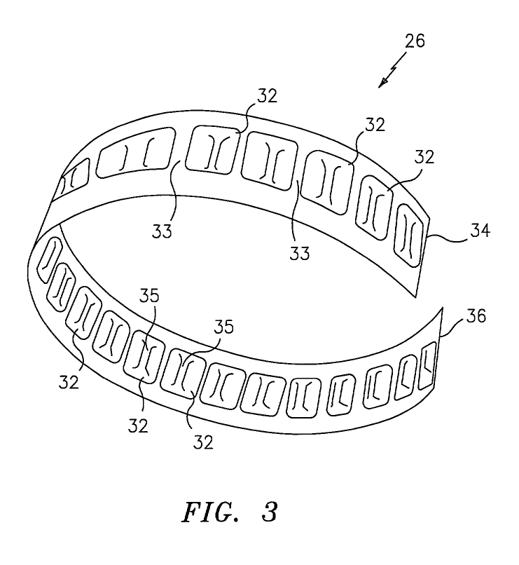

Referring to FIGS. 1-3, the tolerance band 26 is preferably a metal band having ends 34, 36. The band 26 preferably includes a plurality of convolutions or waves 32 formed thereon along the length of its body. Typically, the band 26 would be made from a metal such as steel, however, any suitable material having properties generating a spring rate capable of retaining the stator 20 in housing 16 could be used including elastomeric bands. The band comprises small mostly planar spacer sections 33, which separate each of the waves 32. Each wave 32 has a crest or center section 35 that is offset a distance from the body of the band and may be either curved or flat. To retain the stator 20 in the housing 16, the band 26 is formed to at least partially perimetrically surround stator 20. The band 26 as shown in FIG. 3, is in its free state, outside of the housing groove 27. The band 26, as shown in FIG. 1, is at a predetermined location on the stator 20. In a preferred embodiment, the band is centered along the length of the stator 20. The band 26 is inserted into groove 27 (see FIG. 1) in the motor housing 16. The stator 20 is then pressed into the housing 16 and tolerance band 26 sub-assembly. The clearance 43 serves as a pilot, or guide, for the stator 20 as it is pressed. It is important for the stator 20 to be guided through the tolerance band 26 to insure that it is centered within the housing 16 and the air gap 42 is preserved. The stator 20 is pressed to a distance or a housing shoulder (not shown). As the stator 20 is pressed into the motor housing 16, and through the tolerance band 26, the waves 32 on the band 26 are elastically deformed. The elastic deformation allows the band 26 to act as a radial spring and thus provide the force to retain the stator 20 in the housing 16. The number, size and shape (flat curves, lenticular, circular, etc.) of the waves 32 could be easily altered for a given application to provide any desired holding force while minimizing or eliminating cogging from the motor 10. The specific dimensions of the tolerance band 26 would heavily depend on the application. The size, torque output, thermal range, acceptable addition to cogging and commutation ripple, noise emission, and vibration transmission of the motor will all effect the end design, or sizing of the tolerance band 26, including its spring rate.

During operation, permanent magnet brushless D.C. motors emit undesirable noise and transmit vibration. One type of vibration occurs during the commutation of the stator. This vibration is caused by the energizing and de-energizing of the coils 40 which loads and unloads the teeth 38. As the coils 40 are energized, their magnet fields transmit the load applied to them, to the teeth 38. This load comes and goes as the coil 40 is energized and de-energized, creating a forced vibration, which in turn is transferred into the housing 16. This forced vibration has a tangential and a radial component. The tangential vibration tends to bend the teeth 38, while the radial vibration tends to pull the teeth 38 of stack 21 inward toward the inner diameter, thusly pulling the outer diameter of stack 21 inward.

There are also free vibrations emitted from the stator 20, which act as decaying forcing functions on the surrounding components, e.g. the housing 16. These forcing functions force a vibration, while they have energy, through another structure, such as air, to create airborne noise. When an object is impacted it will resonate with its natural frequency and all its sensitive frequencies. Each time the coils 40 are energized and de-energized they form this function, causing the stator 20 to resonate, or it is said to freely vibrate. This vibration is emitted to the air, transmitted to a mating component, or dissipated by damping. Damping could be added to the system, or occur naturally within it; for example, the copper windings have some natural damping, due to its “dead-like” behavior.

These vibrations and noise can be minimized by isolating the stator 20 from the housing 16. If a spring is placed between the stator 20 and the housing 16 the transmitted vibration can be reduced. By changing the design of the spring, certain frequencies and amplitudes can thus be isolated. The design and its effectiveness depend on the spring's stiffness, the masses of the mating parts, and the frequencies to be isolated. Since the tolerance band 26 acts as a spring, the stator 20 is allowed to move radially, through the clearance 43, without impacting the housing 16. Additionally, a damping material, such as elastomers, rubber, grease, could be added to the groove 27. This damping material would act to dissipate any free vibration of the stator 20 and to absorb some energy from the forced vibration that is transmitted from the stator 20.

The present invention should not be limited in use to a permanent magnet brushless D.C. motor. For instance, a switched reluctance motor has many of the same drawbacks, and would therefore benefit from the use of a tolerance band, or ring. In addition, in order to provide greater stator retention and stability, and enhanced noise and vibration immunity, it might be advantageous to include additional tolerance bands 26 along the length of the stator 20. Although the present invention has been described with reference to certain embodiments, it will be appreciated that these embodiments are not limitations and that the scope of the invention is defined by the following claims.

What is claimed is:

1. A brushless D.C. motor comprising:
a housing;
a stator positioned within said housing; and
at least one radial spring positioned between said housing and said stator to retain said stator within said housing.

2. The brushless D.C. motor of claim 1 wherein said radial spring is a tolerance band having a plurality of waves formed thereon.

3. The brushless D.C. motor of claim 2 wherein said tolerance band has a first and a second end.

4. The brushless D.C. motor of claim 2 wherein said tolerance band is made from steel.

5. The brushless D.C. motor of claim 2 wherein said housing includes a groove and said tolerance band is positioned within said groove.

6. The brushless D.C. motor of claim 5 wherein said housing is made from aluminum.

7. The brushless D.C. motor of claim 5 further comprising a damping material positioned in said groove.

8. The brushless D.C. motor of claim 7 wherein said damping material is a grease.

9. The brushless D.C. motor of claim 7 wherein said damping material is rubber.

10. A tolerance band to press fit a stator in a motor housing comprising:
a length of sheet material; and,
a plurality of wave structures formed in said length of sheet material.

11. A tolerance band as claimed in claim 10 wherein said plurality of wave structures are identical to one another.

12. A tolerance band as claimed in claim 10 wherein at least one of said plurality of wave structures is distinct from a remainder of said wave structures.

13. A tolerance band as claimed in claim 10 wherein said plurality of wave structures are lenticular in shape.

14. A tolerance band as claimed in claim 10 wherein said tolerance band is annular.

15. A tolerance band as claimed in claim 10 wherein said tolerance band includes first and second ends spaced from one another.

16. A tolerance band for a brushless D.C. motor comprising:
a body having a first and second end; and,
a plurality of waves formed between said first and second ends.

17. The tolerance band of claim 16 wherein said plurality of waves are equally spaced between said first and second ends.

18. The tolerance band of claim 17 wherein said body is generally circularly shaped.

19. The tolerance band of claim 17 wherein said waves have a crest offset a predetermined distance from said body.

20. The tolerance band of claim 18 wherein said crest is generally curved in shape.

21. The tolerance band of claim 18 wherein said top portion is generally flat in shape.

22. The tolerance band of claim 18 wherein said tolerance band is made from steel.

23. The tolerance band of claim 18 wherein said tolerance band is made from an elastomeric material.
